(19) United States
(12) Patent Application Publication
(10) Pub. No.: US 2006/0274703 A1
(43) Pub. Date: Dec. 7, 2006

(54) Method and apparatus of filtering and viewing real-time detail records based upon user specific criteria

(76) Inventor: Stephen Philip Connelly, Reston, VA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/145,935

(22) Filed: Jun. 7, 2005

(51) Int. Cl. H04L 1/00

(52) U.S. Cl. 370/338; 370/401; 370/252

(57) ABSTRACT

A method of filtering transaction data from interfaces is provided in a mobile telephony network. In the method, the call data from related frames from the network is filtered to check for network status and provide notification of specified events corresponding to the network. System and computer program products which can execute a method of the invention are also provided.

### BACKGROUND OF THE INVENTION

Telecommunications networks are widely used to link various types of nodes, such as personal computers, servers, gateways, network telephones, and so forth. Networks may include private networks, such as local area networks (LANs) and wide area networks (WAN), and public networks, such as the Internet. Such networks can also be circuit-switched networks in which network resources are dedicated for the entire duration of a data call, and/or packet-switch networks, such as Internet Protocol (IP) networks in which network resources are shared and data in the form of packets or cells are routed independently across the networks along with other user traffic to a destination. Examples of packet-switched networks include Asynchronous Transfer Mode (ATM) networks, Ethernet or Frame Relay, which are based on a virtual circuit model. Popular forms of communications across such networks include electronic mail, file transfer, web browsing, and other exchange of digital data including audio (e.g., voice) and multimedia (e.g., audio and video).

Modern telecommunications networks typically include two related but separate network infrastructures: a bearer or transmission network for carrying end-user voice and data traffic, and a signaling network for controlling the setup and release of bearer channels through the bearer network in accordance with control signals transferred through the signaling network. In practice, such signaling networks comprise high-speed computers interconnected by signaling links, and computer programs implemented to provide a set of operational and signaling functions in accordance with a standardized protocol, such as, for example, the Signalling System No. 7 (SS7) which is being extensively deployed for control of mobile telephony and other data transmission networks. The signaling links are used for passing signaling information (e.g., calls, messages or data) between nodes in the signaling networks. The signaling information (e.g., calls, messages or data) can be captured to generate detail records, such as, Call Detail Records (CDRs) or Transaction Detail Records (TDRs) for storage in a database system which can be subsequently monitored and analyzed for a wide variety of applications, including, for example, quality of service applications and business intelligence applications. In addition to the call and/or transaction detail records (i.e., detail records), other related information sent between nodes, switches or devices in such mobile networks can also be used for authentication, equipment identification and roaming enablement.

Commercially available tools for mobile telephony networks may be used for monitoring the performance and/or quality of a network based on the detail records stored in the database system to observe possible obstacles and track performance statistics in the network. Typically, such monitoring tools are based on monitoring the network for malfunctions at the level of network elements, such as, switches or interfaces, for traffic-related information. However, such actions will result in the collection of vast amounts of data, which cannot be processed in real-time due to the size. Consequently, information from the vast amount of collected data can be revealed to a network administrator or service personnel on a local basis after a certain period of time. For purposes of full time monitoring of a network to detect and provide notification of malfunctions in real-time, such monitoring tools are not very useful.

Moreover, as networks become more complex and large, it becomes increasingly difficult to handle the volume of data. For example, at a given capture point in the network there may be several thousand calls per second, which can quickly overwhelm a user monitoring the mobile network and render any real-time detection of important events impractical. Scanning through the CDRs as they are generated on a real-time basis is difficult and requires that a user be physically present.

Accordingly, it is important to provide users with analysis tools that allow the users to select which data or events are important and to be immediately notified when the events occur. As mentioned above, this becomes especially important as networks become increasingly complex and require capturing and analyzing large volumes of signaling data from various sources. The use of the typical signaling data analysis prevents users from simultaneously analyzing signaling data and requires the users to setup the analysis sessions when there is a need to use only a portion of the signaling data.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates an example mobile telephony network and monitor systems used for signaling analysis of the mobile telephony network;

FIGS. 2A-2B illustrate examples of Call Detail Records (CDRs) obtained from different links in the mobile telephony network shown in FIG. 1;

FIG. 3 is a block diagram of the call filtering system according to an embodiment of the present invention;

FIG. 4 is a block diagram of the call data record filter of FIG. 3 according to an embodiment of the present invention; and

FIG. 5 is a block diagram of the measurement unit of FIG. 3 according to an embodiment of the present invention.

### DETAILED DESCRIPTION OF THE EMBODIMENTS

Before beginning a detailed description of the subject invention, mention of the following is in order. When appropriate, like reference numerals and characters may be used to designate identical, corresponding or similar components in differing figure drawings. Further, in the detailed description to follow, example sizes/values/ranges may be given, although the present invention is not limited to the same. The present invention is also applicable for use with all types of telecommunication networks, including, for example, an Integrated Systems Digital Network (ISDN), a Voice over IP (VoIP) network, the Internet, or mobile telephony networks, such as a Global System for Mobile communication (GSM) network, a General Packet Radio Service (GPRS) network, or a Universal Mobile Telecommunications System (UMTS) network, and the next generation of wireless networks which may become available as technology develops, including CDMA technologies for wireless data services and applications, such as wireless email, web, digital picture taking/sending and assisted-GPS position location applications, and compatible network protocols, such as hyper text transfer protocols (HTTP), file transfer protocols (FTP), VoIP protocols, and UMTS protocols as defined by 3GPP group (see http://www.3gpp.org). However, for the sake of simplicity, discussions will concentrate mainly on exemplary use of an UMTS mobile network, although the scope of the present invention is not limited thereto.

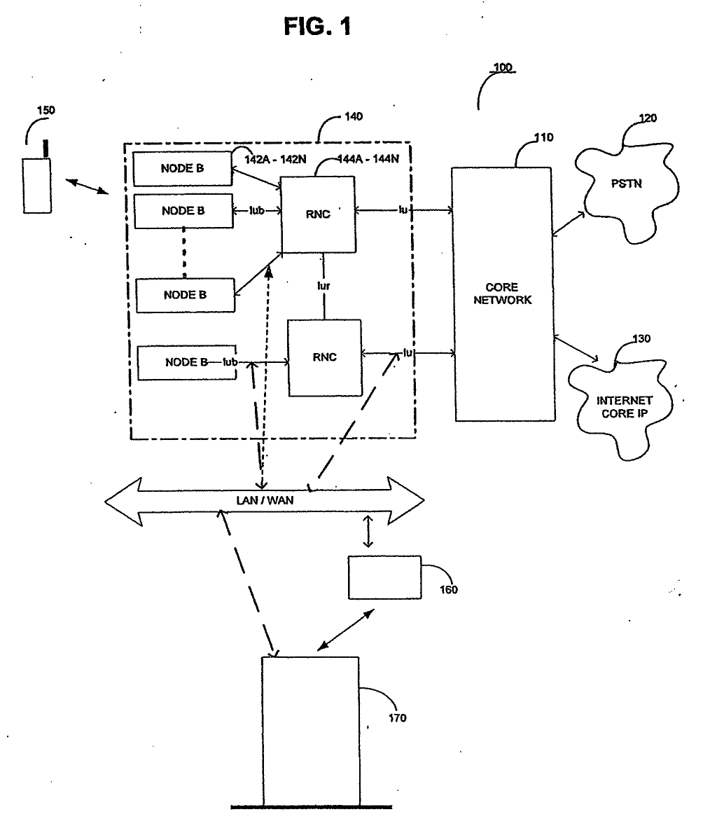

Attention now is directed to the drawings and particularly to FIG. 1, in which an example of a mobile telephony network, such as a universal mobile telecommunications system (UMTS) network is illustrated. As shown in FIG. 1, the mobile telephony network 100 includes a core network 110 which supports circuit-switched networks such as a public switch telephone network (PSTN) 120, and/or packet-switched networks such as Internet Core IP 130; a radio access network 140 connected to the core network 110 to support communications with a user equipment (UE) 150 which is typically a mobile phone, a video phone or a personal digital assistant (PDA). Typically, the core network 110 contains a mobile switching center (MSC) (not shown) supporting communications, via the circuit switched networks such as PSTN 120, and one or more support nodes (not shown) providing a gateway to the packet-switched networks such as Internet core IP 130 and controlling the connection between the network and the user equipment (UE) 150 for wireless communications. The radio access network 140 includes one or more Node “B's”, also known as base stations, 142A-142N, and one or more radio network controllers (RNCs) 144A-144N connected to the localized group of Node B's 142A-142N to select the most appropriate node for the user equipment (UE) 150 and perform handover during wireless communications, when necessary. Network architecture and implementation of the UMTS network 100, including backbone ATM switches, interfaces such as “lu” disposed between the RNCs 144A-144N and the core network 110, “lur” disposed between the RNCs 144A-144N, “lub” disposed between the RNCs 144A-144N and the corresponding Node B's 142A-142N, signaling links between nodes and network elements within the UMTS network 100, and signaling information passing between the signaling links are well-known and, as a result, need not be described in detail herein. However, for purposes of brevity, the signaling information represents data regarding the establishment, control and management of functions of the network 100. Detail records, such as, Call Detail Records (CDRs) of a specific call or Transaction Detail Records (TDRs) of a specific data session can be constructed from related signaling information transmitted between signaling links within the mobile telephony network 100. Generally, a CDR for a specific call is generated by monitoring a link in the network and pulling together all the related frames. The CDRs and TDRs are compilations of a plurality of individual records for a plurality of calls. The terms “CDR” and “TDR” may be seen interchangeable in the context of a mobile telephony network 100 disclosed herein. Similarly, the terms “call” and “data session” can also be used interchangeably, and can be broadly described simply as “transaction.”

Typically, CDRs may have different structures or formats used to define telephone calls originating on land-line telephones, telephone calls terminating on land-line telephones and telephone calls terminating on mobile telephones. However, for purposes of simplicity, CDRs as referred to herein shall represent generic CDRs. Each CDR may correspond to a collection of messages comprising parameters and time-stamps associated with each call which provide detail regarding the call origin, destination, and other details. The parameters and time-stamps associated with each message or collection of information referred to as the “CDR” are the primary pieces of information needed to determine who called whom, how the call was routed and the call disposition for signaling analysis. These CDRs can be monitored and analyzed for a wide variety of applications, including, for example, quality of service applications and business intelligence applications.

As shown in FIG. 1, a monitoring system 160 can be configured to capture traffic, including signaling data, on all key interfaces, including “lub” interfaces, “lur” interfaces, “lu” interfaces or other signaling links, within the mobile telephony network 100 for signaling analysis of the mobile telephony network 100. Such a monitoring system 160 can be coupled to interfaces such as “lub” interfaces connecting one of the RNCs 144A-144N to at least one Node B 142A-142N or “lu” interfaces connecting the RNCs 144A-144N to the core network 110, or ATM switches, either directly, or via a local or wide area network (LAN/NAN), to capture signaling data at a particular interface or signaling link and provide captured signaling data for analysis or collection by a computer (database) system 170. The monitoring system 160 may be, for example, AGILENT™ G6801A Distributed Network Analyzer (DNA) used for capturing all signaling data from a particular signaling link (i.e., interface within the mobile telephony network 100) that relates to a single call or data session, for example, and for controlling the distribution of the signaling data for real-time network testing and analysis, including diagnostics of quality of services and troubleshooting. In addition, software applications, such as AGILENT™ J7326A Signaling Analyzer software (SAS), can be also be installed on the computer system 170, which can be an independent server or host computer system, to decode and analyze captured signaling data locally, with a real-time display. The SAS can also be stored on the monitoring system 160 or any computing system, such as an external PC, a laptop, or a server coupled to a local area network (LAN). The captured signaling data can represent a large number of calls/sessions and can be visually displayed, via a user-configurable window or table format, so that a user (i.e., network administrator or maintenance personnel) can trace each call occurring on the mobile telephony network 100.

Typically, the monitoring system 160 creates Detail Records, such as CDRs, which are assembled by piecing together related individual frames of incoming data streams that are being transported across the mobile telephony network 100 on a real-time basis. Thus, the CDRs are coalesced from the individual frames into a comprehensive record across multiple frames corresponding to calls or data transactions. These CDRs can then be displayed, for example, at the computer system 170 and, alternatively, can be saved off line for later signaling analysis, potentially leaving a long time before signaling analysis can be realized and remedial actions can be taken in response to the signaling analysis. However, when viewing calls within the monitoring system 160 and/or the computer system 170 in real-time, the user (i.e., network administrator or maintenance personnel) can be overwhelmed with the deluge of calls that can take place within the mobile telephony network 100. The user is not able to view all of the CDRs on a real-time basis and make any useful determinations about the network or a particular call because of the volume of information collected by the monitoring system 160.

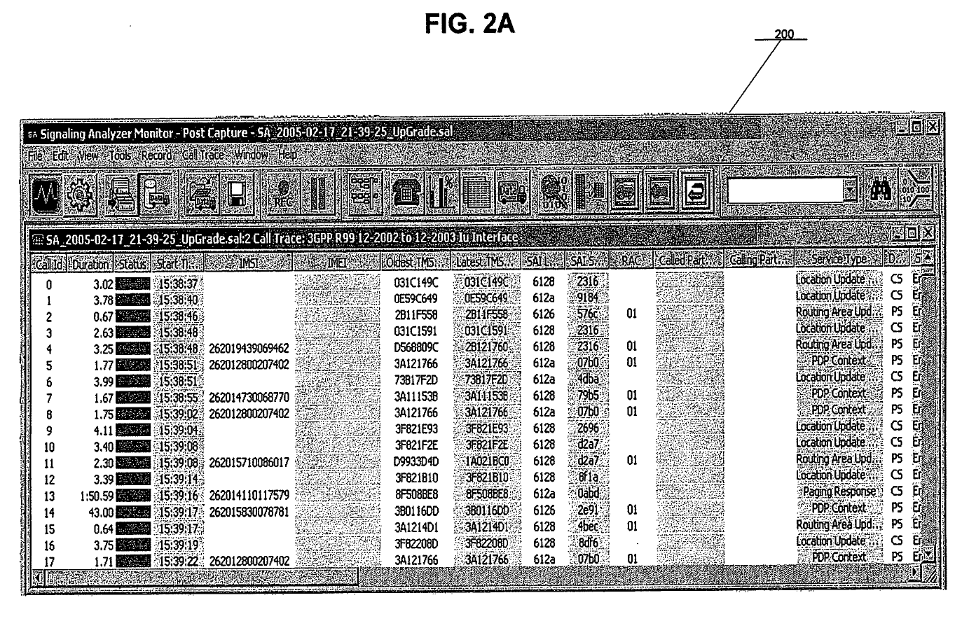

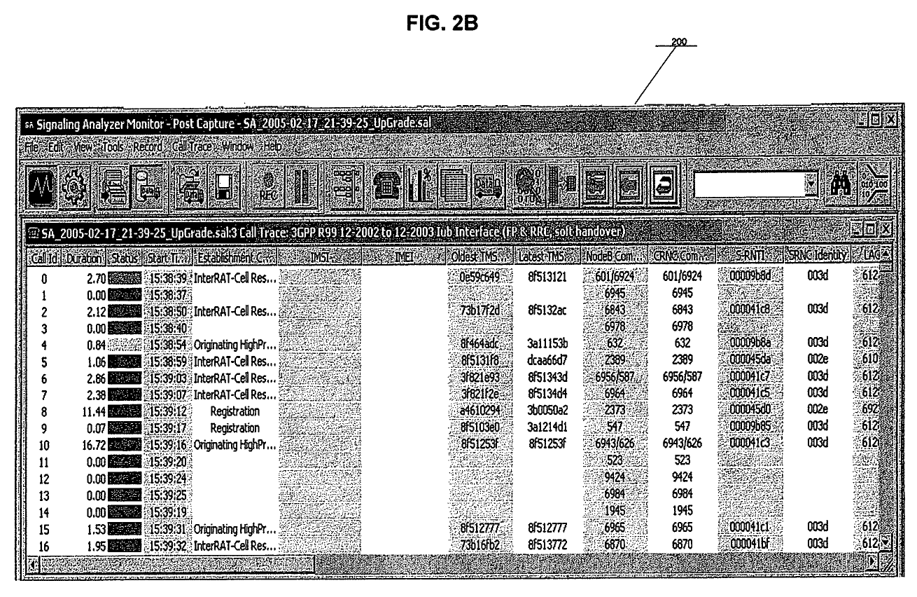

For example, FIGS. 2A-2B illustrate a visual display of different types of Call Detail Records (CDRs) obtained from different signaling links (i.e., interfaces) in the mobile telephone network 100 on a computer system 170. Specifically, FIG. 2A illustrates a visual display of example CDRs obtained from an “lu” interface disposed between the RNCs 144A-144N of the radio access network (RAN) 140 and the core network 110 of the mobile telephony network 100. Alternatively, FIG. 2B illustrates a visual display of example CDRs obtained from an “lub” interface disposed between the RNCs 144A-144N and the corresponding nodes 142A-142N of the radio access network (RAN) 140 of the mobile telephony network 100.

As shown in FIG. 2A and FIG. 2B, each row in the display on the database system 170 represents a call that has occurred or is occurring on the mobile telephony network 100. Each column contains parameters that are particular for a specific call trace which may indicate specific problems. The parameters utilized for an “lu” interface, as shown in FIG. 2A, may include, for example, Call ID, Duration, Status, Start Time, Establishment Cause, IMSI, IMEI, Oldest TMSI/P-TMSI, Latest TMSI/P-TMSI, SAI LAC, SAI SAC, RAC, Called Party BCD Number, Calling Party BCD Number, Service Type, Domain, SCCP Release Cause, RANAP Cause, Setup Time, Cleardown Time, Speech Path/CID, Bad Speech Frames, IPv4 Address, Uplink Packets, Downlink Packets, Uplink Octets, Downlink Octets, Uplink Rate bp/s, and Downlink Rate bp/s. Similarly, the parameters utilized for an “lub” interface, as shown in FIG. 2B, may include, for example, Call ID, Duration, Status, Start Time, Establishment Cause, IMSI, IMEI, Oldest TMSI/P-TMSI, Latest TMSI/P-TMSI, Node B CommCtx ID, CRNC CommCtx ID, S-RNTI, SRNC Identity, LAC, RAC, Cell Identifier, Service Type, Domain, SCCP Release Cause, RANAP Cause, Setup Time, Cleardown Time, Speech Path/CID, Bad Speech Frames, IPv4 Address, Uplink Packets, Downlink Packets, Uplink Octets, Downlink Octets, Uplink Rate bp/s, and Downlink Rate bp/s. One or more of the above information, or the like, comprise one or more of the fields of the CDR.

“Call ID” may represent a unique identifier of a specific call; “Duration” may represent a duration of the completed call, typically configured in hh:mm:ss format; “Status” may represent whether a call is active or terminated. “Start Time” may represent the start time of the call; “IMSI” may represent an International Mobile Subscriber Identity of a subscriber initiating the call; “IMEI” may represent an International Mobile Equipment identifier of equipment manufacturers comprising 14 digits, of which 4 digits are used for the Type Approval Code (TAC), 2 digits are used for the Final Assembly Code (FAC), 6 digits are used for the serial number, and 2 digits are used for the software version number; “Oldest TMSI/P-TMSI” may represent a Temporary Mobile Subscriber Identity (TMSI) and the packet TMS; “Latest TMSI/P-TMSI” may represent the latest TMSI and the packet TMSI; “Service Area Identifier” (SAI) may identify an area consisting of one or more cells belonging to the same Location Area (LA) and may be used for indicating the location of a User Equipment (UE) to the Core Network 150; part of the SAI is the “location area code” (LAC), which can be used to indicate regions having different billing codes or the types of authorized service features; the service area code (SAC) may also related to the SAI and is a fixed length code of 2 octets used to identify a service area (SA) within an LA; the “routing area code” (RAC) may be a fixed length of 1 octet and identifies a routing area within a location area; the RAC may be part of the RAI (Routing Area Identity); “SAI LAC” may represent a Service Area Identifier of the Location Area Code; “SAI SAC” may represent a Service Area Identifier of the Service Area Code; “Called Party BCD Number” may represent a Called Party Binary Coded Decimal Number; “Calling Party BCD Number” may represent a Calling Party Binary Coded Decimal Number; “Node B CommCtx ID” may represent an identifier of the Communication Context in the Node B; “CRNC CommCtx ID” may represent an identifier of the Communication Context of the Node B in the Radio Network Controller (RNC); “S-RNTI” may represent a serving Radio Network Temporary Identity; “SRNC Identity” may represent a serving Radio Network Controller Identity; “Cell Identifier” may represent an identifier of a cell in one Radio Network Controller (RNC); “Service Type” may represent a type of service that occurred during the duration of a call; “Domain” may represent a type of network in which a call is transmitted: Circuit Switched (CS) or Packet Switched (PS); “Release Cause” may represent a criteria for the call to be released; “RANAP Cause” may represent text description of a cause where the Radio Access Network Application Part (RANAP) is used in a UMTS system 100 on the Iu interface; the RANAP generally is responsible for functions including the setting up of a Radio Access Bearer (RAB) between the CN 110 and the RNC 144A-144N; “Signalling Connection Control Part” (SCCP) may refer to the transfer of messages between any two signalling points in the same or different SS7 networks; a “Release”, with respect to the RANAP or the SCCP may represent a process used to identify the release of a channel or call; “Setup Time” may represent a time taken to set up a call or session and may vary depending on the interface (e.g., lu, lub/lu, etc); “Cleardown Time” may represent a time taken to clear down a call or session and may vary for different call traces depending on the interface (e.g., lu, lub/lu, etc.); “Speech Path/CID” may represent VCI/CID that is used for the call; “Bad Speech Frames” may represent a count of the number of bad speech frames that were detected during a call which indicates the level of quality of voice calls during a call; “IPv4 Address” may represent the Internet Protocol Version #4 address; “Uplink Packets” may represent a count of the number of IP packets that the user equipment (UE) has sent to the mobile network 100 during a data session; “Downlink Packets” may represent a count of the number of IP packets that the user equipment (UE) 110 has received from the mobile network 100 during a data session; “Uplink Octets” may represent the count of the number of IP octets that the user equipment (UE) 110 has sent to the mobile network 100 during a data session according to a General packet radio service (GPRS) Tunneling Protocol (GTP); “Downlink Octets” may represent a count of the number of IP packets that the user equipment (UE) has received from the mobile network 100 during a data session; “Uplink Rate bp/s” may represent the average data transfer rate in bits/second that the user equipment (UE) 110 has experienced while sending data to the mobile network 100; “Downlink Rate bp/s” may represent an average data transfer rate in bits/second that the user equipment (UE) 110 has experienced while receiving data from the mobile network 100; and “APN” comprises two parts; the Network ID, which identifies the external service requested by a user of the GPRS service and the Operator ID which specifies routing information. The above criteria list is not intended to be limiting and is presented by way of example for the sake of clarity. It is understood that other criteria would be used for a different format telecommunications network or depending upon user requirements and preferences.

As can be seen from FIGS. 2A-2B, calls and call ID variables generated from captured frames obtained from different signaling links (i.e., interfaces) in the mobile telephony network 100 can be different; nevertheless, these calls have common characteristics such as: Call Type; Start Time; End Time; Successful; or Failure Reason, all of which can be analyzed to identify and pinpoint problems in the mobile telephony network 100. Entries in the CDRs are generated by taking elements from the captured frames that are related to a particular call or line and forming them into a record. However, the user has to sift through the high volume of calls being transported on the mobile telephony network 100 and viewed, for example, on the database system 170. As a result, such a review can be overwhelming. Moreover, when problems are identified, CDRs obtained from the monitoring system 160 contain only a limited subset of information, which in turn only can only be analyzed for limited problems. Therefore, it is beneficial to provide users (i.e., network administrators, client users or maintenance personnel) with improved tools, systems and methods for the management and analysis of detail records in such a mobile telephony network 100, including the ability to filter all calls occurring in the mobile telephony network 100 for a specific type of calls that are of interest, such as, for example, only failed calls, the ability to store remotely and retrieve CDRs given a specific call or data session, and the ability to view the complete frame level detail of the actual CDR for specific signaling analysis in such a mobile telephony network 100.

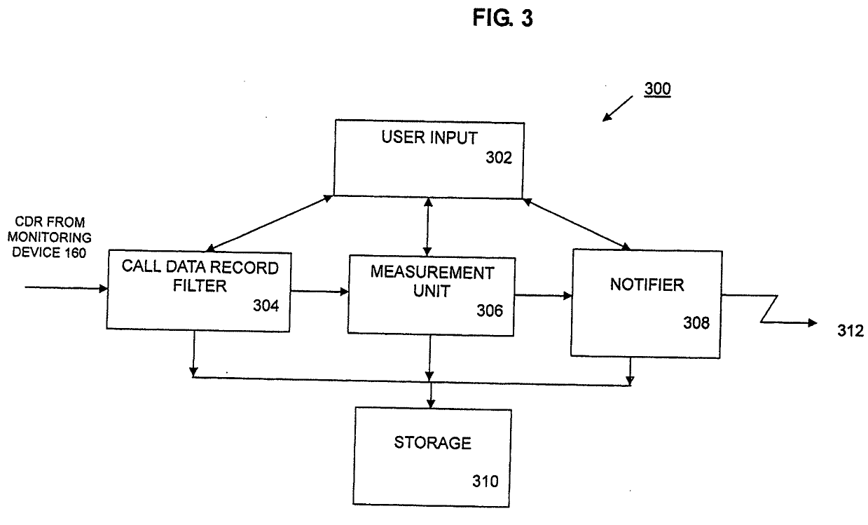

FIG. 3 illustrates an example of the call filtering system 300 according to an embodiment of the present invention. Referring to FIG. 3, the call filtering system 300 comprises a user input 302, a call data record (CDR) filter 304, a measurement unit 306, a notifier 308 and a storage 310. The call filtering system 300 shown represents a computer system 170 comprising a mixture of hardware and a plurality of computer programs executing the elements of the call filtering system 300. The computer system 170 is not limited to a stand alone system and the call filtering system 300 may also be embodied on the monitoring device 160, a laptop, a distributed network or other computing platform. The call filtering system 300 is generally, though not required to be, a separate program from the SAS also residing on the computer system 170. The call filtering system 300 can centrally process and alarm on a real-time basis for multiple links in a monitored network.

The user input 302 is a graphical user interface (GUI) to facilitate clarity and easiness of use. A user will configure the call filtering system 300 through the user input 302 by specifying alarms or notification criteria. The alarms are based on transactions in the mobile telephony network 100. For example, alarm criteria such as Name of Alarm, Call Record Type, Criteria to match (i.e., logical expressions), Amount of times the criteria must match, Time period to perform the alarm, and Notification method can be specified. These are not intended to be a limiting list because different users will want to specify different alarm criteria depending on what aspects of the mobile telephony network that they want to check. The type of alarm criteria specified also changes depending on the format of the network being monitored. However, there is no requirement that the user input 302 be located with the other components of the call filtering system 300. The user input 302 may be programmed to appear to a user at a location remote from the call data record (CDR) filter 304, the measurement unit 306, and the notifier 308. Further, other input mechanisms are possible such as an editable table stored in a memory that is accessed by the CDR filter 304, the measurement unit 306 and the notifier 308. Additionally, defaults for some or all of the alarm criteria may be set so that a user does not need to specify all the data for the alarm criteria.

The call filtering system 300 may be implemented on a single computer system 170 to provide access to different users so that each may use the user input 302 to remotely access the call filtering system 300 and specify different sets of alarm criteria corresponding to each user. This allows each user to specify his own individual alarm criteria to be scanned for using the same CDRs. For example, a first user at a call center may be most focused on abnormal call terminations occurring with a certain time period, while a second user at the call center or at a remote location may want to search the CDRs for any anomalies with 911 call handling. Such an implementation permits a central point to filter and alarm on various generated CDRs from potentially multiple monitored links. This permits the call filtering system 300 to be continually monitoring the network 100 on a real-time basis and provide immediate notification to a user when the specified alarm criteria are met. It is also possible to implement the call filtering system 300 on a portable unit so that a user may go to a specific location to interface with certain data capture points.

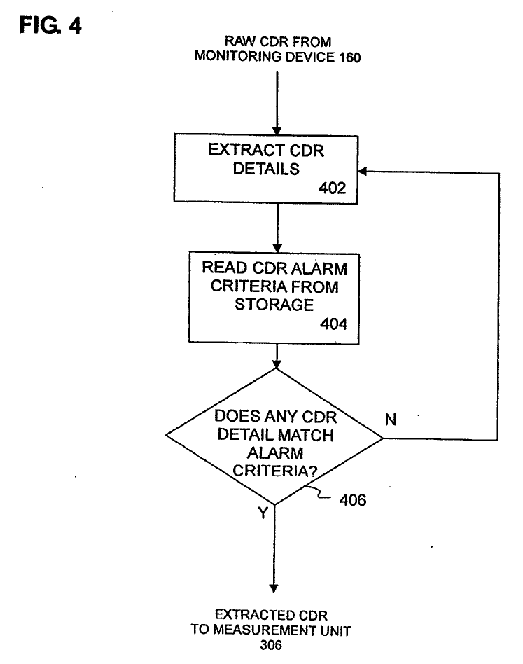

FIG. 4 is a block diagram of the call data record filter 304 of FIG. 3 according to an embodiment of the present invention. Referring to FIG. 4, the CDR filter 304 shown in FIG. 3 extracts details from each CDR received from the monitoring system 160 in operation 402. The CDR filter 304 reads the CDR alarm criteria from the storage 310 in operation 404. The CDR filter 304 checks to see whether any CDR detail matches any of the corresponding alarm criteria in operation 406.

The CDR filter 304 receives raw CDRs from a universal mobile telecommunications system (UMTS) 100 monitoring system 160 described above with respect to FIG. 1. The distributed network analyzers and signaling analyzer software comprising the monitoring system 160 and/or the computer system 170 captures data in the form of individual frames from the UMTS 100 and packages the captured data into CDRs such as those illustrated in FIGS. 2A-2B by coalescing the related frames on a per call or transaction basis. The CDRs are a massive accumulation of data regarding transactions on the UMTS 100. The CDR filter 304 parses or filters this data down to a usable size on a real-time basis so that specific events of interest may be recognized. The CDR filter 304 is not protocol specific and is able to handle many different types of protocols associated with mobile telephony networks such as CDMA, CDMA 2000, GSM, GPRS, etc. The protocols are a function of where in a telecommunications network the data is captured and the format of the telecommunications network. The CDR filter 304 is able to process the raw CDR regardless of the protocol used in that section of the telecommunications network that is being monitored.

The call filtering system 300 is able to avoid protocol dependencies because the call filtering system 300 receives the CDRs from the monitoring system 160. The monitoring system 160 must be able to interface with the protocols at the section of the particular telecommunications network being monitored. However, the call filtering system 300 only needs data from the compiled CDRs and does not require a specific protocol. This is because the user specifies what criteria of the CDRs are important and the call filtering system 300 then searches for matching criteria.

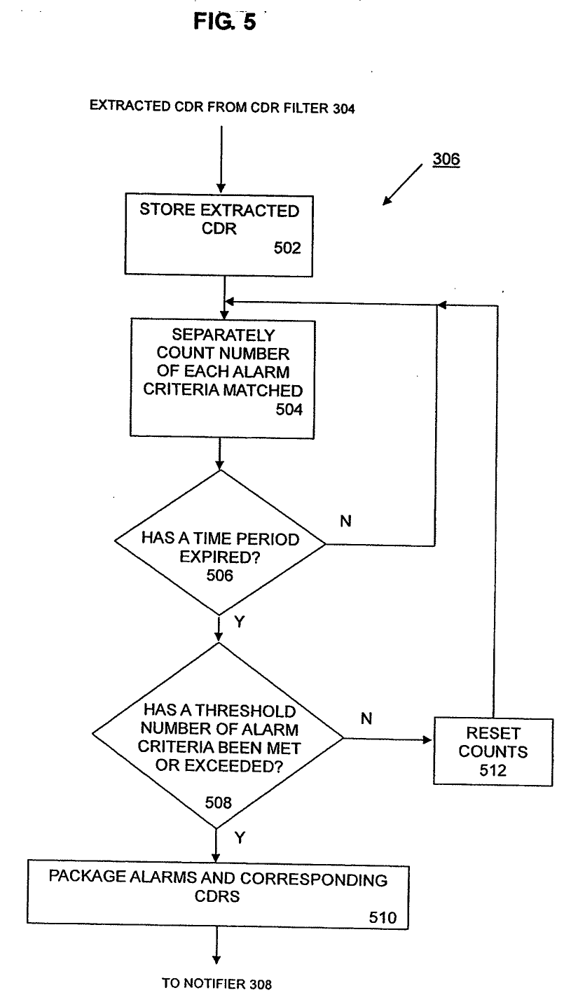

FIG. 5 is a block diagram of the measurement unit 306 of FIG. 3 according to an embodiment of the present invention. Referring to FIG. 5, the measurement unit 306 stores the extracted CDR from the CDR filter 304 in operation 502. For each alarm criteria a separate count is maintained. For each extracted CDR that matches one of the alarm criteria the count is incremented in operation 504. In operation 506, whether a time period of interest has expired is checked. The time period may be specified by the user or may be preset to a default. If the time period has not expired, the measurement unit 306 continues to count extracted CDRs that match the alarm criteria. If the time period has expired, then in operation 508 the measurement unit 306 checks whether a given count exceeds meets or exceeds a threshold corresponding to that alarm criteria. If the count meets or exceeds the threshold alarm criteria then the alarms and corresponding extracted CDRs are bundled or packaged and transmitted to the notification unit 308 in operation 510. If the count has not met or exceeded the threshold then all counts for the alarm criteria are reset in operation 512 and the process is repeated for another CDR.

The time window n, which the count must meet the threshold within, may be a fixed or variable length of time. The length of time may occur in sequential blocks such that the system is continually counting in a shifting frame of reference of the same n length. For example, the first time period would include block t and block t+1 each of length n/2 and the second time period would be include block t+2 and block t+3 each also of length n/2. Also, the time window may roll such that the counting time window always includes a portion of the previous window together with a new portion to equal the entire time block. For example, the first time window would include block t and block t+1 each of length n/2, and the second time window would include block t+1 and block t+2 each of length n/2. In this way, the call filtering system is able to catch anomalies that occur during any length time period.

The notifier 308 controls notification of the user when the threshold is exceeded. The notifier 308 packages basic information about the CDR that matched the alarm criteria and the time window. For example, the notifier 308 might bundle together a message that ten (10) abnormal call terminations occurred in a 1 minute window at a certain time of day and transmit 312 the bundled message to the user. Once notified the user is then able to investigate the actual calls that triggered the notification and take appropriate corrective action. Such investigation can occur because of the storage 310. The notifier 308 may, for example, use email notification, pager, text messaging, Simple Network Management Protocol (SNMP) Trap, or any combination thereof. The notifier 308 transmits the notification to the user via the specified method.

The storage 310 serves as a central repository to maintain all settings for the alarms so the users can add/edit/delete alarms. The notification method used may also be kept in the storage 310. The storage 310 may be a hard disk drive, optical disc and drive or other accessible memory storage. The storage 310 may be located on the computer system 170 with the call data record (CDR) filter 304, the measurement unit 306, and the notifier 308 or it may be located separately in a remote location or on an external drive. By only storing CDRs that match the alarm criteria the amount of storage required is manageable when compared to the massive storage required to store every CDR.

An example of the operation of the call filtering system 300 with a specific example of the alarm criteria that may be used is shown in Table 1 and described below.

TABLE 1

| Criteria | Value |
|---|---|
| Name of Alarm | Iu abnormal releases |
| Call Record Type | 3GPP 12-2002 to 12-2003 Iu |
| | Interface |
| Criteria to match | RANAP Cause = ‘Abnormal Release’ |
| The minimum of times this criteria | 10 |
| must match | |
| Time period to perform the alarm | 60 seconds |
| Notification | SNMP Trap |

In this example, a user accesses the user input 302 and specifies alarm criteria of ten (10) abnormal call releases and a time period of 60 seconds as illustrated in Table 1. The abnormal call release criteria is assumed to be one of the call detail record (CDR) fields that are generated by the monitoring system 160 and/or the computer system 170. The user also specifies SNMP Trap as the desired notification method when the alarm criteria are met using the user input 302. The call filtering system 300 receives CDRs as a stream through an interface with the monitoring system 160 and/or the computer system 170 and begins a clock to keep track of the time period specified in the measurement unit 306 which runs until the specified time period of 60 seconds has expired and then resets.

In this example, the interface is multiple lu interfaces of the telecommunications network 100. Each CDR comprises many entries each including different fields related to signaling data that is processing as a plurality of related individual frames through the telecommunications network 100 which is being monitored. The CDR filter 304 extracts data from the fields of the CDR. Then the CDR filter 304 checks the extracted field data to see if there is a match in one of the fields to the specified alarm criteria (i.e., in this example case the alarm criteria is any abnormal call release). If there are no matching criteria (i.e, no abnormal releases in the RANAP Cause field) then the CDR filter 304 extracts the next set or entry of CDR data and checks for matching alarm criteria again. When an abnormal call release is detected, the CDR filter 304 sends the extracted CDR entry to the measurement unit 306 and the storage 310 in order to maintain all the CDRs that match the alarm criteria.

The measurement unit 306 increments a counter to indicate that a CDR matching the alarm criteria was detected. The measurement unit 306 checks to see if the specified time period of 60 seconds has expired. If the time period is still active then the measurement unit 306 continues counting each CDR that matches the abnormal release criteria. Once the time period of 60 seconds has expired then the measurement unit 306 checks to see if at least 10 abnormal releases have occurred. If 10 or more abnormal releases have occurred within the 60 second window that was specified then the measurement unit 306 packages each of the CDRs or an entry of the CDRs that match the alarm criteria of an abnormal release within the 60 second window and transmits them to the notifier 308. If there have been fewer than 10 abnormal releases in the 60 second period then the measurement unit 306 resets the count and starts counting matching abnormal releases again with a new 60 second time period window.

The notifier 308 receives the packaged CDRs that matched the alarm criteria and provides notification to the user in the manner specified. In this case, the notifier 308 sends a SNMP Trap configured to include a time stamp, the number of matches to the alarm criteria and an object identifier which identifies the monitoring system 160 which sent the CDRs. It is to be understood that other trap fields of the SNMP trap could also be specified. The notifier 308 could also simply send a page or short text message to the user indicating a time of alarm and the affected system. When the user receives the relevant entries of the CDR that triggered the alarm then at a glance the user can tell the extent of the problem and determine an appropriate course of action.

The call filtering system 300 can be software modules written, via a variety of software languages, including C, C++, Java, Visual Basic, and many others. The various software modules may also be integrated in a single application executed on one or more control units (not shown), such as a microprocessor, a microcontroller, or a processor card (including one or more microprocessors or microcontrollers) in the computer system 170, for example, as shown in FIG. 1. Alternatively, the software modules can also be distributed in different applications executed by different computing systems, such as the monitoring system 160, the computer system 170, or any other computing devices connected to the mobile telephony network 100. For example, the call data record filter 304 and the measurement unit 306 may reside on the monitoring system 160, as shown in FIG. 1. The notifier 308 may reside on the computer system 170. Similarly, the call data record filter 304, the measurement unit 306 and the notifier 308 may reside on the same computer system 170, or alternatively, another computing device, such as an external PC, a laptop, or a server coupled to a local area network (LAN). The storage 310 and the user input 302 may be stored on a separate computer system or on the same computer system 170 with the other components. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs).

Instructions of the software routines or modules may also be loaded or transported into the monitoring system 160, the computer system 170 or any computing devices on the mobile telephony network 100 in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

The call filtering system provides a real-time capability to filter and alarm on generated call detail records according to defined criteria from multiple monitored links of a telecommunications network from a central point.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A call filtering system for use in a mobile telephony network, comprising:
an inputter receiving alarm events from a first user corresponding to transaction functions in the mobile telephony network;
a transaction data record filter receiving, on a real-time basis, transaction data records comprising data combined together from related frames from the mobile telephony network, and determining whether the transaction data records match the alarm events;
a measurement unit counting a number of the matches of the alarm events occurring during a time window; and
a notifier providing network status notification to the first user, when the number of the matches of the alarm events exceeds a threshold.

2. The call filtering system of claim 1, wherein the transaction data record filter filters the alarm events from a remote central location.

3. The call filtering system of claim 1, wherein the inputter accepts inputs from a plurality of other users each specifying at least one or more combinations of the alarm events, the time window or the network status notification that are different relative to the first user.

4. The call filtering system of claim 3, further comprising a storage storing the transaction data records that match the alarm events, the alarm events, the time window, and the number of the matches of the alarm events in the time window.

5. The call filtering system of claim 1, wherein a second user specifies another set of alarm events, another time window and another method of network status notification using the transaction data records.

6. The call filtering system of claim 1, wherein the time window scrolls such that a portion of the previous time window is considered with a new time period.

7. The call filtering system of claim 1, wherein the time window is a fixed length of sequential time blocks.

8. The call filtering system of claim 1, wherein the time window is a series of overlapping fixed length blocks.

9. A machine readable medium having embodied thereon a program for execution by a machine, the program capable of filtering data in a mobile telephony network, comprising:
receiving detail transaction records comprising data from related frames from one or more monitored links in the mobile telephony network;
specifying first event criteria corresponding to events of interest in the mobile telephony network;
evaluating each detail transaction record for a match to the specified first event criteria on a real-time basis;
storing each matching detail transaction record; and
notifying a user when a threshold of the detail transaction records matching the first event criteria is exceeded.

10. The machine readable medium of claim 9, wherein the receiving the detail transaction records comprises coalescing the data from the related frames corresponding to individual transactions within the mobile telephony network.

11. The machine readable medium of claim 9, further comprising inputting second event criteria and a type of the notifying to be executed by the program when the threshold for the second event criteria is exceeded.

12. The machine readable medium of claim 9, further comprising:
specifying second event criteria to be evaluated together with the first event criteria.

13. The machine readable medium of claim 9, wherein the evaluating each detail transaction record further comprises counting a number of matches within a predetermined time window.

14. The machine readable medium of claim 13, wherein the predetermined time window scrolls such that a portion of a previous time window is considered with a new time period.

15. The machine readable medium of claim 13, wherein the predetermined time window is a fixed number of sequential time blocks.

16. The machine readable medium of claim 13, wherein the predetermined time window is a series of overlapping fixed time period blocks.

17. A method of filtering call data in a mobile network monitoring system, comprising:
capturing call data frames from at least one location in the mobile network;
generating call data records by associating related captured call data frames into the call data records on a real-time basis;
filtering generated call data records according to first and second predetermined criteria indicating network events;
analyzing filtered call data records to determine whether the first and second predetermined criteria match the filtered call data records at least a threshold number of times within a time range; and
notifying a user when the threshold corresponding to the first predetermined criteria is exceeded or the threshold corresponding to the second predetermined criteria is exceeded.

18. The method of claim 17, wherein the filtering of the generated call data records is performed from a remote location after a set period of time.

19. The method of claim 17, wherein the time range is a series of overlapping fixed time period blocks.

20. The method of claim 17, wherein the time range is a series of sequential time blocks.
